(19) United States
(12) Patent Application Publication
(10) Pub. No.: US 2026/0132268 A1
(43) Pub. Date: May 14, 2026

(54) THERMOPLASTIC RESIN COMPOSITION FOR ELECTROMAGNETIC WAVE ABSORBER AND MOLDED BODY

(71) Applicants: artience Co., Ltd., Tokyo (JP); TOYOCOLOR CO., LTD., Tokyo (JP)

(72) Inventors: Yuta KOBAYASHI, Tokyo (JP); Moe OKAWA, Tokyo (JP)

(73) Assignees: artience Co., Ltd., Tokyo (JP); TOYOCOLOR CO., LTD., Tokyo (JP)

(21) Appl. No.: 18/868,778

(22) PCT Filed: Jul. 13, 2023
(86) PCT No.: PCT/JP2023/025935

§ 371 Date: Nov. 25, 2024

(30) Foreign Application Priority Data
Aug. 3, 2022 (JP) 2022-124303

(51) Int. Cl. C08K 3/04

(52) U.S. Cl. CPC C08K 3/041

(57) ABSTRACT

A thermoplastic resin composition for an electromagnetic wave absorber includes a thermoplastic resin (A), a carbon nanotube (B) with an average diameter of 1 to 15 nm, and a carbon black (C) with an average primary particle size of 20 to 50 nm, and satisfies any of (i) to (iv). ΔRL expressed by Equation (1) is 3 dB or less, and ΔTL expressed by Equation (2) is 5 dB or less.

### TECHNICAL FIELD

An embodiment of the present invention relates to a thermoplastic resin composition for an electromagnetic wave absorber and a molded body.

### RELATED ART

Plastics are easy to mold and process and have thus been used in a wide range of fields such as electrical and electronic device parts, automobile parts, medical parts, and food containers. To enhance decorative properties or impart functionality, coloring of plastic molded products is commonly performed. Particularly in the automotive field, molded bodies colored for the purpose of electromagnetic wave absorption applications are circulating as products with imparted functionality.

Electromagnetic waves are radiated from communication devices such as radios, televisions, and wireless communication devices. In addition, electromagnetic waves are also radiated from electronic devices such as mobile phones and personal computers, which have rapidly increased due to recent advancements in information technology. Conventionally, as one method for avoiding malfunction of electronic devices and communication devices due to electromagnetic waves, electromagnetic wave absorbers that efficiently absorb electromagnetic waves and convert the absorbed electromagnetic waves into thermal energy are installed near or far from electromagnetic wave generation sites.

An example of installing and using an electromagnetic wave absorber far from the electromagnetic wave generation site is the application of electronic toll collection (ETC) systems on highways. The ETC is a system that exchanges billing information and the like using microwaves with a frequency of 5.8 GHz between a roadside antenna installed at a toll booth and a vehicle-mounted antenna when a vehicle passes through a toll booth exit on the highway. At toll booths at which the ETC system has been introduced, abnormalities may occur in communication due to reasons that microwaves radiated from the antenna are reflected off the toll booth roof and the like, or unwanted electromagnetic waves leak from adjacent ETC lanes, for example. Thus, electromagnetic wave absorbers are installed on the toll booth roof and between ETC lanes to suppress communication abnormalities.

Further, in recent years, in the automotive field, millimeter wave radars are being used for the purpose of autonomous driving and collision prevention of vehicles, and in many cases, millimeter wave radar devices are installed inside the automobiles.

Millimeter waves refer to electromagnetic waves with a wavelength of 1 to 10 mm and a frequency of 30 to 300 GHz, and are currently used in vehicle-mounted radars, full-body scanners seeing through clothing for security checks at airports and the like, and transmission of images of surveillance cameras on platforms during one-man operation of trains. Millimeter wave radar devices are devices capable of recognizing obstacles by emitting millimeter waves and receiving the reflected waves. Since the detectable range is large and susceptibility to interference by sunlight, rain, and fog is low, millimeter wave radar devices are used today in autonomous driving technologies of automobiles and the like. In the case of a sensor of an automobile, the millimeter wave radar device can detect relative distances and relative velocities with respect to obstacles by transmitting and receiving millimeter waves from antennas.

The transmission and reception antennas of the millimeter wave radar devices may also receive reflections from road surfaces and the like other than the targeted obstacles, and detection accuracy of the device may decrease. To solve this problem, the millimeter wave radar devices are provided with electromagnetic wave absorbers as shielding members that shield electromagnetic waves between an antenna and a control circuit.

As electromagnetic wave absorption materials of the millimeter wave band range that constitute such electromagnetic wave absorbers, carbon-based materials, metal-carbon-based materials, and magnetic materials are known. In recent years, the carbon nanotube (CNT) as a carbon-based material has been attracting attention with its high conductivity and relatively light weight.

Having high conductivity, resin compositions including the carbon nanotube are used in parts requiring conductivity in the fields of automobiles, home appliances, and building materials (Patent Document 1), and are used as electromagnetic wave absorbers utilizing the electromagnetic wave properties (Patent Documents 2 and 3).

### RELATED ART DOCUMENTS

### Patent Documents

Patent Document 1: Japanese Patent Application Laid-Open No. 2016-108524
Patent Document 2: Japanese Patent Application Laid-Open No. 2017-512847
Patent Document 3: Japanese Patent Application Laid-Open No. 2016-504471

### SUMMARY OF INVENTION

### Problem to be Solved by Invention

However, in molded bodies using these conventional resin compositions, electromagnetic wave absorption performance cannot be said to be sufficient regarding a reflection loss and a transmission loss of electromagnetic waves for sufficiently protecting the radar from the surrounding environment without interfering with signal transmission of the radar.

Further, the carbon nanotube is a material with a relatively high aspect ratio and is thus difficult to disperse. In the case of insufficient dispersion, lumps or welds (a phenomenon where wave-like patterns appear) may occur on the surface of the molded body, and may impair the appearance. Furthermore, the carbon nanotube tends to orient in specific directions during molding, and angle dependence, in which electromagnetic wave absorption performance of the molded body varies depending on the incident angle of the electromagnetic waves, also becomes a problem.

Thus, since it is difficult to achieve both high conductivity and dispersion stability of the carbon nanotube, an objective of the present invention is to provide a thermoplastic resin composition for an electromagnetic wave absorber that is excellent in dispersibility, and a molded body that exhibits excellent electromagnetic wave absorption performance with both a low reflection loss and a transmission loss, and further has a small angle dependence of electromagnetic wave absorption performance.

Specifically, an objective of the present invention is to provide a molded body for a millimeter wave absorber that is excellent in terms of the reflection loss and the transmission loss in a specific frequency band of 60 to 90 GHz, which is called millimeter waves.

### Means for Solving Problem

Upon intensive studies, the inventors of the present invention have found that the problem of the present invention can be solved in the following aspects, and have completed the present invention.

In other words, the present invention includes the following embodiments.

An embodiment relates to a thermoplastic resin composition for an electromagnetic wave absorber including:
a thermoplastic resin (A), a carbon nanotube (B) with an average diameter of 1 to 15 nm, and a carbon black (C) with an average primary particle size of 20 to 50 nm.
the thermoplastic resin composition for an electromagnetic wave absorber satisfying any of (i) to (iv) below, in which
ΔRL expressed by Equation (1) below is 3 dB or less, and ΔTL expressed by Equation (2) below is 5 dB or less.
(i): the thermoplastic resin (A) includes a polyolefin resin (A1) with an MFR of 5.0 to 50 g/10 min at a temperature of 230° C. and a load of 2.16 kgf;
(ii): the thermoplastic resin (A) includes a polyamide resin (A2) with an MFR of 5.0 to 50 g/10 min at a temperature of 240° C. and a load of 2.16 kgf;
(iii): the thermoplastic resin (A) includes a polyester resin (A3) with an MFR of 5.0 to 50 g/10 min at a temperature of 280° C. and a load of 1.2 kgf;
(iv): the thermoplastic resin (A) includes a polycarbonate resin (A4) with an MFR of 5.0 to 50 g/10 min at a temperature of 280° C. and a load of 1.2 kgf:

$$Δ RL = \vert RL ( MD ) - RL ( TD ) \vert \qquad Equation ( 1 )$$

$$Δ TL = \vert TL ( MD ) - TL ( TD ) \vert \qquad Equation ( 2 )$$

(where RL(MD) and RL(TD) are respectively transmission attenuation amounts when electromagnetic waves with a frequency of 76.5 GHz are incident onto a thickness direction of a molded body, with an electric field direction of the electromagnetic waves being in a direction (MD direction) parallel to an injection direction or in a direction (TD direction) perpendicular to the injection direction, after leaving the molded body standing for one day, the molded body being 90 mm in length, 110 mm in width, and 3 mm in thickness and is molded from the thermoplastic resin composition for an electromagnetic wave absorber using an injection molding machine,
further, TL(MD) and TL(TD) are respectively reflection attenuation amounts when electromagnetic waves with a frequency of 76.5 GHz are incident onto a thickness direction of a molded body, with an electric field direction of the electromagnetic waves being in a direction (MD direction) parallel to an injection direction or in a direction (TD direction) perpendicular to the injection direction, after leaving the molded body standing for one day, the molded body being 90 mm in length, 110 mm in width, and 3 mm in thickness and is molded from the thermoplastic resin composition for an electromagnetic wave absorber using an injection molding machine, and
further, the length of the molded body is in the injection direction).

Another embodiment relates to a molded body formed from the thermoplastic resin composition for an electromagnetic wave absorber described above.

### Effect of Invention

The thermoplastic resin composition for an electromagnetic wave absorber of the present invention is excellent in dispersibility, and an electromagnetic wave absorber obtained therefrom exhibits excellent electromagnetic wave absorption performance with both a low reflection loss and a low transmission loss and furthermore has a small angle dependence of electromagnetic wave absorption performance.

Specifically, since the present invention is excellent in terms of the reflection loss and the transmission loss in the specific frequency band of 60 to 90 GHz, which is call millimeter waves, it can be suitably used also as a molded body for a millimeter wave absorber.

### BRIEF DESCRIPTION OF DRAWINGS

FIG. 1 is a conceptual view illustrating measurements of a transmission attenuation amount and a reflection attenuation amount using a millimeter wave transmission device.

FIG. 2 is a conceptual view illustrating measurement of incident angle dependence using a millimeter wave transmission device.

### DESCRIPTION OF EMBODIMENTS

The present invention will be described in detail below.

In this specification, a numerical value range specified using “A to B” includes numerical values “A” and “B” as a range of a lower limit value and an upper limit value.

Further, a carbon nanotube may be referred to as a CNT, and “a carbon nanotube (B) with an average diameter of 1 to 15 nm”. “a carbon black (C) with an average primary particle size of 20 to 50 nm”, “a polyolefin resin (A1) with an MFR of 5.0 to 50 g/10 min at a temperature of 230° C. and a load of 2.16 kgf”. “a polyamide resin (A2) with an MFR of 5.0 to 50 g/10 min at a temperature of 240° C. and a load of 2.16 kgf”, “a polyester resin (A3) with an MFR of 5.0 to 50 g/10 min at a temperature of 280° C. and a load of 1.2 kgf”, “a polycarbonate resin (A4) with an MFR of 5.0 to 50 g/10 min at a temperature of 280° C. and a load of 1.2 kgf”, and “a thermoplastic resin composition for an electromagnetic wave absorber” may be respectively referred to as “a carbon nanotube (B)”. “a carbon black (C)”, “a polyolefin resin (A1)”. “a polyamide resin (A2)”, “a polyester resin (A3)”, “a polycarbonate resin (A4)”, and “a thermoplastic resin composition”.

Further, unless specifically noted otherwise, various components described in this specification may be respectively used independently as one type or as a combination of two or more types.

Numerical values specified in this specification are values obtained according to methods disclosed in the embodiment or Examples.

The MFR in the embodiment of the present invention is a value obtained by measuring each thermoplastic resin in a value of a melt mass-flow rate in accordance with JIS K7210.

### <<Thermoplastic Resin Composition for Electromagnetic Wave Absorber>>

According to the embodiment of the present invention, the thermoplastic resin composition is used for forming an electromagnetic wave absorber.

The thermoplastic resin composition includes a thermoplastic resin (A), a carbon nanotube (B) with an average diameter of 1 to 15 nm, and a carbon black (C) with an average primary particle size of 20 to 50 nm, and satisfies any of (i) to (iv) below.

(i): The thermoplastic resin (A) includes a polyolefin resin (A1) with an MFR of 5.0 to 50 g/10 min at a temperature of 230° C. and a load of 2.16 kgf.

(ii): The thermoplastic resin (A) includes a polyamide resin (A2) with an MFR of 5.0 to 50 g/10 min at a temperature of 240° C. and a load of 2.16 kgf.

(iii): The thermoplastic resin (A) includes a polyester resin (A3) with an MFR of 5.0 to 50 g/10 min at a temperature of 280° C. and a load of 1.2 kgf.

(iv): The thermoplastic resin (A) includes a polycarbonate resin (A4) with an MFR of 5.0 to 50 g/10 min at a temperature of 280° C. and a load of 1.2 kgf.

In this manner, by using a carbon nanotube with a small average diameter and a carbon black with a small average primary particle size in a specific range in combination with a thermoplastic resin (A) that satisfies any of (i) to (iv), orientational properties of the carbon nanotube in a molded body can be controlled, stability of the carbon nanotube in the thermoplastic resin composition is excellent, and orientation when formed into a molded body can be suppressed.

Further, ΔRL expressed by Equation (1) below is 3 dB or less, and ΔTL expressed by Equation (2) below is 5 dB or less.

$$Δ RL = \vert RL ( MD ) - RL ( TD ) \vert \qquad Equation ( 1 )$$

$$Δ TL = \vert TL ( MD ) - TL ( TD ) \vert \qquad Equation ( 2 )$$

(Herein, RL(MD) and RL(TD) are respectively transmission attenuation amounts when electromagnetic waves with a frequency of 76.5 GHz are incident onto a thickness direction of a molded body, with an electric field direction of the electromagnetic waves being in a direction (MD direction) parallel to an injection direction or in a direction (TD direction) perpendicular to the injection direction, after leaving the molded body standing for one day, the molded body being 90 mm in length, 110 mm in width, and 3 mm in thickness and is molded from the thermoplastic resin composition for an electromagnetic wave absorber using an injection molding machine.

Further, TL(MD) and TL(TD) are respectively reflection attenuation amounts when electromagnetic waves with a frequency of 76.5 GHz are incident onto a thickness direction of a molded body, with an electric field direction of the electromagnetic waves being in a direction (MD direction) parallel to an injection direction or in a direction (TD direction) perpendicular to the injection direction, after leaving the molded body standing for one day, the molded body being 90 mm in length, 110 mm in width, and 3 mm in thickness and is molded from the thermoplastic resin composition for an electromagnetic wave absorber using an injection molding machine.

Further, the length of the molded body is in the injection direction.)

Further, the injection direction referred to herein is a direction in which the thermoplastic resin composition flows from a gate portion of a molding machine into a mold.

In other words, the molded body which is 90 mm in length, 110 mm in width, and 3 mm in thickness refers to a molded body that has a length of 90 mm in the injection direction, a length of 110 mm in a direction perpendicular to the injection direction, and a thickness of 3 mm.

Further, from the perspective of dispersibility and incident angle dependence, based on the thermoplastic resin composition (100 mass %), a total content ratio of the carbon nanotube (B) and the carbon black (C) is preferably 6 to 18 mass %, more preferably 6 to 15 mass %, and even more preferably 8 to 13 mass %.

In the embodiment of the present invention, it is important not only to set ΔRL expressed by Equation (1) to 3 dB or less and ΔTL expressed by Equation (2) to 5 dB or less, but also to further use a carbon nanotube (B) with a small average diameter and a carbon black (C) with a relatively small average primary particle size in a specific particle size range in combination with a thermoplastic resin (A) that satisfies any of (i), (ii), (iii), or (iv). In addition, by further setting respective formulation amounts as low as possible in specific ranges, it becomes possible to control orientational properties of the carbon nanotube and the carbon black, and exhibit sufficient electromagnetic wave absorption performance in the case of incidence of electromagnetic waves in a direction parallel to the injection direction of the molded body as well as in the case of incidence of electromagnetic waves in a perpendicular direction, and angle dependence of the electromagnetic wave absorber can be further suppressed.

### <Thermoplastic Resin (A)>

The thermoplastic resin (A) is a resin capable of being molded by heat melting, and the thermoplastic resin composition of the embodiment of the present invention satisfies any of (i) to (iii) below.

(i): The thermoplastic resin (A) includes a polyolefin resin (A1) with an MFR of 5.0 to 50 g/10 min at a temperature of 230° C. and a load of 2.16 kgf.

(ii): The thermoplastic resin (A) includes a polyamide resin (A2) with an MFR of 5.0 to 50 g/10 min at a temperature of 240° C. and a load of 2.16 kgf.

(iii): The thermoplastic resin (A) includes a polyester resin (A3) with an MFR of 5.0 to 50 g/10 min at a temperature of 280° C. and a load of 1.2 kgf.

(iv): The thermoplastic resin (A) includes a polycarbonate resin (A4) with an MFR of 5.0 to 50 g/10 min at a temperature of 280° C. and a load of 1.2 kgf.

The polyolefin resin (A1), the polyamide resin (A2), the polyester resin (A3), or the polycarbonate resin (A4) has a high fluidity when melted, and by selecting such a thermoplastic resin and using in combination with the carbon black (C) and the carbon nanotube (B), it becomes possible to suppress orientation of the carbon nanotube when formed into the molded body, and a thermoplastic resin composition that has the effect of a low angle dependence of electromagnetic wave absorption can be obtained.

In contrast, if the fluidity when melted becomes high at a specific value or more, a skin layer with a relatively low concentration of the carbon nanotube (B) and a core layer with a relatively high concentration of the carbon nanotube (B) are formed on the surface and inside of the molded body, and a concentration gradient occurs. Thus, by selecting and using the thermoplastic resin described above, a molded body with a uniform carbon nanotube concentration can be obtained, and the effect of a low angle dependence of electromagnetic wave absorption is achieved.

In each embodiment of (i), (ii), (iii), or (iv), based on the thermoplastic resin (A), the polyolefin resin (A1), the polyamide resin (A2), the polyester resin (A3), or the polycarbonate resin (A4) is preferably used alone, respectively, and at least any one of the polyolefin resin (A1), the polyamide resin (A2), the polyester resin (A3), and the polycarbonate resin (A4) is preferably a main component.

The main component refers to a component of a highest content ratio among the thermoplastic resins constituting the thermoplastic resin (A).

Specifically, in each embodiment, based on the thermoplastic resin (A), the content ratio of the polyolefin resin (A1), the polyamide resin (A2), the polyester resin (A3), or the polycarbonate resin (A4) is preferably 80 mass % or more, more preferably 90 mass % or more, and particularly preferably 100 mass %.

### [Polyolefin Resin (A1)]

The polyolefin resin (A1) is a polyolefin resin with an MFR of 5.0 to 50 g/10 min at a temperature of 230° C. and a load of 2.16 kgf.

The polyolefin resin (A1) is a polymer composed of olefins (monomers), and examples thereof specifically include a polyethylene resin (PE) such as high-density polyethylene (HDPE), low-density polyethylene (LDPE), linear low-density polyethylene (LLDPE), a polypropylene resin (PP), an ethylene-α-olefin copolymer, an ethylene-vinyl acetate copolymer, an ethylene-vinyl alcohol copolymer, an ethylene-ethyl acrylate copolymer, a cyclic olefin resin such as a cyclo-olefin polymer and a cyclo-olefin copolymer, etc. From the perspective of versatility and fluidity, the low-density polyethylene (LDPE), the linear low-density polyethylene (LLDPE), or the polypropylene resin (PP) is preferable. These polyolefin resins may be oxidized polyolefins in which the polyolefin is partially oxidized. Further, the polyolefin resin (A1) may be used alone or as a combination of two or more types.

Further, in the embodiment of the present invention, the polyolefin resin (A1) has an MFR at a temperature of 230° C. and a load of 2.16 kgf that is within a range of 5.0 to 50 g/10 min. preferably within a range of 15 to 40 g/10 min, and particularly preferably within a range of 25 to 35 g/10 min. Being within the above range is preferable in terms of incident angle dependence.

### [Polyamide Resin (A2)]

The polyamide resin (A2) is a polyamide resin with an MFR of 5.0 to 50 g/10 min at a temperature of 240° C. and a load of 2.16 kgf.

The polyamide resin (A2) is a polycondensate having an amide bond, and examples thereof specifically include nylon 4,6, nylon 6, nylon 6,6, nylon 6,10, nylon 6,12, nylon 12, nylon 6,T, nylon 9,T, aromatic nylon resin, etc. From the perspective of versatility and fluidity, the nylon 6 and the nylon 6,6 are preferable. Further, the polyamide resin (A2) may be used alone or as a combination of two or more types.

Further, in the embodiment of the present invention, the polyamide resin (A2) has an MFR at a temperature of 240° C. and a load of 2.16 kgf that is within a range of 5.0 to 50 g/10 min, preferably within a range of 15 to 40 g/10 min, and particularly preferably within a range of 25 to 35 g/10 min. Being within the above range is preferable in terms of incident angle dependence.

### [Polyester Resin (A3)]

The polyester resin (A3) is a polyester resin with an MFR of 5.0 to 50 g/10 min at a temperature of 280° C. and a load of 1.2 kgf.

The polyester resin (A3) is a polycondensate having an ester bond, and examples thereof specifically include polyethylene terephthalate resin, polybutylene terephthalate resin, polyethylene naphthalate resin, amorphous copolyester resin, etc. From the perspective of versatility and fluidity, the polyethylene terephthalate resin or the polybutylene terephthalate resin is preferable. Further, the polyester resin (A3) may be used alone or as a combination of two or more types.

Further, in the embodiment of the present invention, the polyester resin (A3) has an MFR at a temperature of 280° C. and a load of 1.2 kgf that is within a range of 5.0 to 50 g/10 min. preferably within a range of 15 to 40 g/10 min, and particularly preferably within a range of 25 to 35 g/10 min. Being within the above range is preferable in terms of incident angle dependence.

### [Polycarbonate Resin (A4)]

The polycarbonate resin (A4) is a polycarbonate resin with an MFR of 5.0 to 50 g/10 min at a temperature of 280° C. and a load of 1.2 kgf.

The polycarbonate resin (A4) is a polycondensate in which a junction part between monomer units is a carbonate group. Specifically, a resin that is easily manufactured by reacting an aromatic dihydroxy compound with a carbonate precursor such as phosgene or carbonic diester may be used. As manufacturing of the resin, for example, in the case of using phosgene as the carbonate precursor, the resin may be obtained according to an interfacial method, and in the case of using carbonic diester, the resin may be obtained according to transesterification in which the reaction is carried out in a melted state.

Further, in the embodiment of the present invention, the polycarbonate resin (A4) has an MFR at a temperature of 280° C. and a load of 1.2 kgf that is within a range of 5.0 to 50 g/10 min. preferably within a range of 15 to 40 g/10 min, and particularly preferably within a range of 25 to 35 g/10 min. Being within the above range is preferable in terms of incident angle dependence.

From the perspective of electromagnetic wave absorption performance, based on the thermoplastic resin composition (100 mass %), a content ratio of the thermoplastic resin (A) is preferably 82 mass % or more, more preferably 84 mass % or more, and even more preferably 85 mass % or more. Further, the content ratio of the thermoplastic resin (A) is preferably 94 mass % or less, more preferably 92 mass % or less, and even more preferably 90 mass % or less. The content ratio of the thermoplastic resin (A) may be, for example, 82 to 94 mass %, 84 to 92 mass %, or 85 to 90 mass %.

### <Carbon Nanotube (B)>

The carbon nanotube (B) has an average diameter of 1 to 15 nm as determined by a scanning electron microscope. It is preferably within a range of 1 to 10 nm. By being within this range, dispersibility of the carbon nanotube in the thermoplastic resin composition is high, and electromagnetic wave absorption performance of the molded body is excellent.

The average diameter of the carbon nanotube may be specifically determined using, for example, a scanning electron microscope (e.g., JSM-6700M manufactured by JEOL Ltd.). Conditions are as follows: the carbon nanotube is observed at an accelerating voltage of 5 kV, an image at 50,000× magnification (1024× 1280 pixels) is captured, then a short axis length of each of 20 randomly selected carbon nanotubes in the captured image is measured, and a number-average value of the short axis lengths is calculated as the average diameter of the carbon nanotube.

The carbon nanotube (B) may be a single-walled carbon nanotube, a multi-walled carbon nanotube with two or more layers, or a mixture thereof. However, the multi-walled carbon nanotube is preferable in terms of cost and strength. Further, a carbon nanotube with a sidewall having an amorphous structure rather than a graphite structure may also be used.

The carbon nanotube (B) may generally be manufactured according to methods such as laser ablation, arc discharge, chemical vapor deposition (CVD), and a combustion method, and the carbon nanotube may be manufactured according to any method. In particular, the CVD method is a method in which the carbon nanotube can be produced inexpensively and in large quantities by bringing a carbon-containing gas as a raw material into contact with catalyst microparticles carrying a metal catalyst such as iron or nickel on a carrier such as silica, alumina, magnesium oxide, titanium oxide, silicates, diatomaceous earth, alumina-silica, silica-titania, zeolites, etc., under high temperatures of 400 to 1000° C. This method is preferable for the carbon nanotube used in the embodiment of the present invention.

From the perspective of electromagnetic wave absorption performance, based on the thermoplastic resin composition (100 mass %), a content ratio of the carbon nanotube (B) is preferably 0.1 mass % or more, more preferably 0.5 mass % or more, and even more preferably 1 mass % or more. Further, the content ratio of the carbon nanotube (B) is preferably 5 mass % or less, more preferably 3 mass % or less, and even more preferably 2 mass % or less. The content ratio of the carbon nanotube (B) may be, for example, 0.1 to 5 mass %, 0.5 to 5 mass %, 1 to 3 mass %, or 1 to 2 mass %.

### <Carbon Black (C)>

The carbon black (C) has an average primary particle size of 20 to 50 nm as determined by a scanning electron microscope. It is preferably 25 nm or more. Further, it is preferably 40 nm or less, and more preferably 35 nm or less. By using a carbon black (C) with an average primary particle size within this range, after injection molding or extrusion molding, the carbon nanotubes (B) incorporated inside the molded body can effectively form conductive paths with each other, and it becomes possible to stably exhibit high conductivity and electromagnetic wave absorption performance.

The average primary particle size of the carbon black is specifically determined using, for example, a scanning electron microscope (e.g., JSM-6700M manufactured by JEOL Ltd.). Conditions are as follows: the carbon black is observed at an accelerating voltage of 5 kV, an image at 50,000× magnification (1024× 1280 pixels) is captured, then a particle size of each of 20 randomly selected carbon blacks in the captured image is measured, and a number-average value thereof is calculated as the average primary particle size of the carbon black.

In a thermoplastic resin composition in which only the carbon nanotube is formulated as a conductive material, it is difficult to exhibit high conductivity in the case of performing injection molding to manufacture the molded body, even if the carbon nanotube is sufficiently dispersed in the composition. The reason thereof is believed to lie in that a layer (so-called “skin layer”) in which a ratio of presence of the resin is high and a concentration of the carbon nanotube is low is formed on the surface of the molded body. In other words, when a portion with a high ratio of presence of the resin and a low concentration of the carbon nanotube and a portion with a low ratio of presence of the resin and a high concentration of the carbon nanotube are both present in the thermoplastic resin composition, since the viscosity (melt viscosity) during melting differs between each portion, for example, in the case of extrusion molding, the portion with a high ratio of presence of the resin, which has a low viscosity and a high fluidity, is extruded first during molding, the surface of the molded body is covered with a skin layer, and it is estimated that conductivity of the molded body decreases.

On the other hand, since the carbon black generally has a low specific surface area and a low oil absorption compared to the carbon nanotube, in a thermoplastic resin composition containing the carbon black, the melt viscosity is less likely to increase, and a skin layer is less likely to form on the surface of the molded body, compared to a thermoplastic resin composition containing only the carbon nanotube. Further, since the carbon black has good affinity with the carbon nanotube, even if the carbon nanotube is incorporated inside the molded body, conductive paths can be formed with respect to the carbon black present on the surface of the molded body. Thus, the molded body of the embodiment of the present invention can exhibit high conductivity.

In other words, according to the embodiment of the present invention, by using the carbon nanotube (B) with a small average diameter and the carbon black (C) with a relatively small average primary particle size within a specific range in combination in the thermoplastic resin composition, orientational properties of the carbon nanotube and the carbon black in the molded body are controlled, and it becomes possible to exhibit sufficient electromagnetic wave absorption performance not only in the case where electromagnetic waves are incident in a direction parallel to the injection direction of the molded body, but also in the case where electromagnetic waves are incident in a perpendicular direction.

As the carbon black (C), various types may be used alone, or two or more types may be used in combination, including a furnace black manufactured by continuously thermally decomposing gaseous or liquid raw materials in a reaction furnace, a Ketjen black made particularly from ethylene heavy oil as a raw material, a channel black obtained by burning a raw material gas and rapidly cooling its flame on a bottom surface of a channel steel for precipitation, a thermal black obtained by periodically repeating burning and thermal decomposition with a gas as a raw material, an acetylene black particularly with an acetylene gas as a raw material, etc. Further, a carbon black subjected to an oxidization treatment, which is generally performed, a hollow carbon, etc. may also be used.

Examples of commercially available carbon blacks include, for example, a furnace black manufactured by Nippon Steel Carbon Co., Ltd. such as Niteron #10, #200, and #300, a furnace black manufactured by Tokai Carbon Co., Ltd. such as Toka Black #4300, #4400, #4500, and #5500, a furnace black manufactured by Degussa such as Printex L, a furnace black manufactured by Columbian such as Raven 7000, 5750, 5250, 5000 ULTRA III, 5000 ULTRA, Conductex SC ULTRA, 975 ULTRA, PUER BLACK 100, 115, and 205, a furnace black manufactured by Mitsubishi Chemical Corporation such as #30B, #45, #2350, #2400B. #2600B, #30050B, #3030B, #3230B, #3350B, #3400B, and #5400B, a furnace black manufactured by Cabot Corporation such as MONARCH 1400, 1300, 900, Vulcan XC-72R, and Black Pearls 2000, a furnace black manufactured by Imerys such as Ensaco 250G, Ensaco 260G, Ensaco 350G, and Super P-Li, a Ketjen black manufactured by Akzo such as Ketjen Black EC-300J and EC-600JD, and an acetylene black manufactured by Denka Company Limited such as Denka Black HS-100 and FX-35, etc. However, the carbon black is not limited to these examples.

From the perspective of electromagnetic wave absorption performance, based on the thermoplastic resin composition (100 mass %), a content ratio of the carbon black (C) is preferably 3 mass % or more, more preferably 5 mass % or more, and even more preferably 7 mass % or more. Further, the content ratio of the carbon black (C) is preferably 16 mass % or less, more preferably 15 mass % or less, and even more preferably 12 mass % or less. The content ratio of the carbon black (C) may be, for example, 3 to 16 mass %, 5 to 15 mass %, or 7 to 12 mass %.

Further, a ratio (mass (%)/mass (%)) of contents of the carbon nanotube (B) to the carbon black (C) is preferably within a range of carbon nanotube (B)/carbon black (C)=1/2.5 to 1/20, and more preferably within a range of 1/5 to 1/15.

### <Other Optional Components>

The thermoplastic resin composition may include, as required, other optional components such as an electromagnetic wave absorption material, a weather stabilizer, an antistatic agent, a dye, a pigment, a coupling agent, a crystal nucleating agent, and a resin filler.

The thermoplastic resin composition preferably does not include a volatile component.

In 100 mass % of the thermoplastic resin composition, a volatile component such as a solvent and a low molecular weight component is preferably 5 mass % or less, and more preferably 1 mass % or less.

As the electromagnetic wave absorption material, a carbon nanotube, a carbon black, etc. other than the carbon nanotube (B) and the carbon black (C) may be included within a range that does not impair the effects of the present invention. From the perspective of electromagnetic wave absorption performance, in 100 mass % of the electromagnetic wave absorption material. contents of the carbon nanotube (B) and the carbon black (C) are preferably high, more preferably 50 to 100 mass %, even preferably 70 to 100 mass %, and particularly preferably 90 to 100 mass %.

In 100 mass % of the electromagnetic wave absorption material, a content ratio of the electromagnetic wave absorption material other than the carbon nanotube (B) and the carbon black (C) is preferably 10 mass % or less, and more preferably 5 mass % or less.

If dispersibility of the carbon nanotube is poor, a high addition amount would become required when attempting to achieve electromagnetic wave absorption performance within a range for practical use. However, although the high addition amount improves transmission loss performance, since electromagnetic waves are reflected, electromagnetic wave absorption performance decreases.

Further, in the case of attempting to achieve electromagnetic wave absorption performance using the carbon black, which has poorer conductivity compared to the carbon nanotube, an addition amount higher than that of the carbon nanotube would become required. As concentrations of these electromagnetic wave absorption materials become high in the resin composition, the fluidity of the resin composition decreases, and uniform electromagnetic wave absorption performance may not be obtained in the molded product due to poor distribution.

However, in the embodiment of the present invention, in the thermoplastic resin composition, by using the carbon nanotube (B) with an average diameter of 1 to 15 nm and the carbon black (C) with an average primary particle size of 20 to 50 nm in combination and further having a specific relationship between the reflection attenuation amount and the transmission attenuation amount, it becomes possible to achieve high electromagnetic wave absorption performance and suppression of angle dependence in the molded body without configuring a high addition amount of the electromagnetic wave absorption material.

### <Manufacturing Method of Thermoplastic Resin Composition>

A manufacturing method of the thermoplastic resin composition of the embodiment of the present invention is not particularly limited.

For example, the thermoplastic resin (A), the carbon nanotube (B), the carbon black (C), further, additives as required, etc. may be added, mixed using a Henschel mixer, a tumbler, a disperser, etc., and mixed and melt-kneaded using a batch kneader, a twin-screw extruder, a single-screw extruder, a rotor-type twin-screw kneader, etc., such as a kneader, a roll mill, a super mixer, a Henschel mixer, a Schugi mixer, a vertical granulator, a high-speed mixer, a Pharmatrix, a ball mill, a steel mill, a sand mill, a vibration mill, an attritor, and a Banbury mixer, to obtain a resin composition in a form of pellets, powder, granules, or beads.

In the embodiment of the present invention, a twin-screw extruder is preferably used for melt-kneading.

In the embodiment of the present invention, the thermoplastic resin composition may be a masterbatch that contains relatively high concentrations of the carbon nanotube (B) and the carbon black (C) and is diluted with the thermoplastic resin (A) for use during molding, or may be a compound that has relatively low concentrations of the carbon nanotube (B) and the carbon black (C) and is supplied for molding in its original composition without dilution with the thermoplastic resin (A). From the perspective of formulation costs, inventory costs, etc., a masterbatch capable of being highly concentrated is preferable. The masterbatch is preferably in the form of pellets, which is easy to handle.

### <<Molded Body>>

The molded body is formed from the thermoplastic resin composition of the embodiment of the present invention and is used for an electromagnetic wave absorber.

The molded body may be obtained by melting and mixing the compound, which is the thermoplastic resin composition, or the masterbatch, with a diluting resin in a molding machine generally set at 50° C. to 350° C., and then forming a shape of the molded body and performing cooling. The temperature of the molding machine would not be a problem as long as it is a temperature at which the thermoplastic resin (A) softens, but is a temperature 30° C. or more higher than a softening point of the thermoplastic resin serving as the main component.

The shape of the molded body may be preferably obtained in a form such as a plate, a rod, a fiber, a tube, a pipe, a bottle, and a film.

The molding method may involve, for example, extrusion molding, injection molding, blow molding, compression molding, transfer molding, film molding such as T-die molding and inflation molding, calendar molding, spinning, etc.

According to the embodiment of the present invention, in the thermoplastic resin composition, since orientational properties of the carbon nanotube (B) can be highly controlled, even in an injection molded body or an extrusion molded body in which orientational properties are likely to occur, excellent effects in high electromagnetic wave absorption performance and suppression of angle dependence can be exhibited.

From the perspective of electromagnetic wave absorption performance, based on the thermoplastic resin composition (100 mass %), a content ratio of the carbon nanotube (B) of the molded body is preferably 0.1 mass % or more, more preferably 0.5 mass % or more, and even more preferably 1 mass % or more. Further, the content ratio of the carbon nanotube (B) of the molded body is preferably 5 mass % or less, more preferably 3 mass % or less, and even more preferably 2 mass % or less. The content ratio of the carbon nanotube (B) may be, for example, 0.1 to 5 mass %, 0.5 to 5 mass %, 1 to 3 mass %, or 1 to 2 mass %.

Further, from the perspective of electromagnetic wave absorption performance, based on the thermoplastic resin composition (100 mass %), a content ratio of the carbon black (C) of the molded body is preferably 3 mass % or more, more preferably 5 mass % or more, and even more preferably 7 mass % or more. Further, the content ratio of the carbon black (C) of the molded body is preferably 16 mass % or less, more preferably 15 mass % or less, and even more preferably 12 mass % or less. The content ratio of the carbon black (C) may be, for example, 3 to 16 mass %, 5 to 15 mass %, or 7 to 12 mass %.

The electromagnetic wave absorber converts and absorbs energy of incident electromagnetic waves into thermal energy inside the absorber. Different from an electromagnetic wave shielding material, the purpose of the electromagnetic wave absorber is to absorb electromagnetic waves inside the molded body without reflecting the electromagnetic waves on the molded body surface.

The electromagnetic wave absorber is used in an electronic toll collection system (ETC) on highways, a vehicle-mounted radar, a full-body scanner seeing through clothing for security checks at airports and the like, a millimeter wave radar device used for transmission of images of surveillance cameras on platforms during one-man operation of trains, radar false image prevention of ship masts, etc.

Specifically, since the molded body formed by the thermoplastic resin composition in the embodiment of the present invention is also excellent in electromagnetic wave absorption performance in a millimeter wave band range of frequency 60 to 90 GHz, it can also be suitably used in a millimeter wave radar device.

Examples of the embodiment of the present invention are provided below. The present invention is not limited to the following.

[1] A thermoplastic resin composition for an electromagnetic wave absorber including:
a thermoplastic resin (A), a carbon nanotube (B) with an average diameter of 1 to 15 nm, and a carbon black (C) with an average primary particle size of 20 to 50 nm,
the thermoplastic resin composition for an electromagnetic wave absorber satisfying any of (i) to (iv) below, in which
ΔRL expressed by Equation (1) below is 3 dB or less, and ΔTL expressed by Equation (2) below is 5 dB or less.
(i): the thermoplastic resin (A) includes a polyolefin resin (A1) with an MFR of 5.0 to 50 g/10 min at a temperature of 230° C. and a load of 2.16 kgf;
(ii): the thermoplastic resin (A) includes a polyamide resin (A2) with an MFR of 5.0 to 50 g/10 min at a temperature of 240° C. and a load of 2.16 kgf;
(iii): the thermoplastic resin (A) includes a polyester resin (A3) with an MFR of 5.0 to 50 g/10 min at a temperature of 280° C. and a load of 1.2 kgf;
(iv): the thermoplastic resin (A) includes a polycarbonate resin (A4) with an MFR of 5.0 to 50 g/10 min at a temperature of 280° C. and a load of 1.2 kgf;

$$Δ RL = \vert RL ( MD ) - RL ( TD ) \vert \qquad Equation ( 1 )$$

$$Δ TL = \vert TL ( MD ) - TL ( TD ) \vert \qquad Equation ( 2 )$$

(where RL(MD) and RL(TD) are respectively transmission attenuation amounts when electromagnetic waves with a frequency of 76.5 GHz are incident onto a thickness direction of a molded body, with an electric field direction of the electromagnetic waves being in a direction (MD direction) parallel to an injection direction or in a direction (TD direction) perpendicular to the injection direction, after leaving the molded body standing for one day, the molded body being 90 mm in length, 110 mm in width, and 3 mm in thickness and is molded from the thermoplastic resin composition for an electromagnetic wave absorber using an injection molding machine.
further, TL(MD) and TL(TD) are respectively reflection attenuation amounts when electromagnetic waves with a frequency of 76.5 GHz are incident onto a thickness direction of a molded body, with an electric field direction of the electromagnetic waves being in a direction (MD direction) parallel to an injection direction or in a direction (TD direction) perpendicular to the injection direction, after leaving the molded body standing for one day, the molded body being 90 mm in length, 110 mm in width, and 3 mm in thickness and is molded from the thermoplastic resin composition for an electromagnetic wave absorber using an injection molding machine, and
further, the length of the molded body is in the injection direction).

[2] The thermoplastic resin composition for an electromagnetic wave absorber according to [1], in which based on the thermoplastic resin composition for an electromagnetic wave absorber, a total content ratio of the carbon nanotube (B) and the carbon black (C) is 6 to 18 mass %. For example, the total content ratio of the carbon nanotube (B) and the carbon black (C) may be 6 to 15 mass %

[3] The thermoplastic resin composition for an electromagnetic wave absorber according to [1] or [2], in which based on the thermoplastic resin composition for an electromagnetic wave absorber, a content ratio of the thermoplastic resin (A) is 82 to 94 mass %. For example, the content ratio of the thermoplastic resin (A) may be 85 to 90 mass %.

[4] The thermoplastic resin composition for an electromagnetic wave absorber according to any one of [1] to [3], in which based on the thermoplastic resin composition for an electromagnetic wave absorber, a content ratio of the thermoplastic resin (A) is 82 to 94 mass %, a content ratio of the carbon nanotube (B) is 1 to 3 mass %, and a content ratio of the carbon black (C) is 5 to 15 mass %. For example, the content ratio of the thermoplastic resin (A) may be 85 to 90 mass %, the content ratio of the carbon nanotube (B) may be 1 to 3 mass %, and the content ratio of the carbon black (C) may be 5 to 12 mass %.

[5] A molded body formed from the thermoplastic resin composition for an electromagnetic wave absorber according to any one of [1] to [4].

The disclosure of the present application is related to the subject matter described in Japanese Patent Application No. 2022-124303, filed on Aug. 3, 2022, the entire disclosure of which is incorporated herein by reference.

### EXAMPLES

Hereinafter, the present invention will be described in further detail based on Examples, but Examples below do not limit the present invention in any manner. In Examples, “parts” refers to “parts by mass”, and “%” refers to “mass %”. Further, the formulation amounts in the tables are in mass %, and blank columns in the tables indicate that the component is not added.

The average diameter of the carbon nanotube, the average primary particle size of the carbon black, and the MFR of the thermoplastic resin (A) were measured according to the following methods.

### <Average Diameter of Carbon Nanotube>

The carbon nanotube was observed using a scanning electron microscope (JSM-6700M manufactured by JEOL Ltd.) at an accelerating voltage of 5 kV, and an image was captured at 50,000× magnification (1024×1280 pixels). Then, in the captured image, a short axis length of each of 20 randomly selected carbon nanotubes was measured, and a number-average value of the short axis lengths was determined as the average diameter of the carbon nanotube.

### <Average Primary Particle Size of Carbon Black>

The carbon black was observed using a scanning electron microscope (JSM-6700M manufactured by JEOL Ltd.) at an accelerating voltage of 5 kV, and an image was captured at 50,000× magnification (1024× 1280 pixels). Then, in the captured image, a particle size of each of 20 randomly selected carbon blacks was measured, and a number-average value thereof was determined as the average primary particle size of the carbon black.

### <Melt Mass-Flow Rate (MFR) of Thermoplastic Resin (A)>

The MFR of the thermoplastic resin (A) was measured using a melt indexer manufactured by TOYO SEIKI co., LTD., in accordance with JIS K7210.

The measurements were obtained under the following conditions: for a polyolefin resin, at a temperature of 230° C. and a load of 2.16 kgf; for a polyamide resin, at a temperature of 240° C. and a load of 2.16 kgf; for a polyester resin, at a temperature of 280° C. and a load of 1.2 kgf; and for a polycarbonate resin, at a temperature of 280° C. and a load of 1.2 kgf.

The materials used in Examples are as follows.

### <Thermoplastic Resin (A)>

(A1-1) Prime Polypro J107G (polypropylene resin manufactured by Prime Polymer Co., Ltd.)
(A1-2) Prime Polypro J106G (polypropylene resin manufactured by Prime Polymer Co., Ltd.)
(A1-3) Sun Allomer PM802A (polypropylene resin manufactured by Sun Allomer Ltd.)
(A2-4) Amilan CM1017 (nylon 6 manufactured by Toray Industries, Inc.)
(A3-5) Duranex 700FP (polybutylene terephthalate resin manufactured by Polyplastics Co., Ltd.)
(A4-6) Iupilon H3000 (polycarbonate resin manufactured by Mitsubishi Engineering-Plastics Corporation)
(A5-7) Sun Allomer PMB60A (polypropylene resin manufactured by Sun Allomer Ltd.)
(A5-8) Sun Allomer PM472W (polypropylene resin manufactured by Sun Allomer Ltd.)
(A5-9) Crystalline polyamide resin (MFR 0.1 g/10 min or less at 240° C.×1.2 kgf, MFR 60 g/10 min at 300° C.×10 kgf)

Table 1 summarizes the MFR of the thermoplastic resin (A) under respective conditions.

TABLE 1

| | | | MFR |
|---|---|---|---|
| | Type | Conditions | [g/10 min] |
| A1-1 | Polyolefin resin | 230° C. × 2.16 kgf | 30 |
| A1-2 | Polyolefin resin | 230° C. × 2.16 kgf | 9 |
| A1-3 | Polyolefin resin | 230° C. × 2.16 kgf | 20 |
| A2-4 | Polyamide resin | 240° C. × 2.16 kgf | 35 |
| A3-5 | Polyester resin | 280° C. × 1.2 kgf | 30 |
| A4-6 | Polycarbonate resin | 280° C. × 1.2 kgf | 35 |
| A5-7 | Polyolefin resin | 230° C. × 2.16 kgf | 63 |
| A5-8 | Polyolefin resin | 230° C. × 2.16 kgf | 2.7 |
| A5-9 | Polyamide resin | 240° C. × 2.16 kgf | 60 |

### <Carbon Nanotube (B) and the Like>

(B-1) Flotube 7000 (manufactured by CNano, average diameter 6.0 nm)
(B-2) SMW210 (manufactured by South West NanoTechnologies, average diameter 9.0 nm)
(B-3) CM-130 (manufactured by Hanwha Chemical hanos, average diameter 15.0 nm)
(B′-1) NTP3121 (manufactured by NTP, average diameter 30.0 nm)

### <Carbon Black (C) and the Like>

(C-1) Mitsubishi Carbon #30B (manufactured by Mitsubishi Chemical Corporation, average primary particle size 30 nm)
(C-2) Niteron #10 (furnace black manufactured by Nippon Steel Carbon Co., Ltd., average primary particle size 39 nm)
(C-3) Ensaco250G (furnace black manufactured by Imerys, average primary particle size 45 nm)
(C′-1) Mitsubishi Carbon #3030B (manufactured by Mitsubishi Chemical Corporation, average primary particle size 55 nm)
(C′-2) Mitsubishi Carbon #900B (manufactured by Mitsubishi Chemical Corporation, average primary particle size 16 nm)

### (Manufacturing of Thermoplastic Resin Composition)

### Example 1

The thermoplastic resin (A1-1) 89 mass %, the carbon nanotube (B-1) 1 mass %, and the carbon black (C-1) 10 mass % were mixed and melt-kneaded, then extruded at 230° C. using a twin-screw extruder (manufactured by The Japan Steel Works, LTD.), and pelletized to obtain the thermoplastic resin composition.

### Example 2 to Example 14

Thermoplastic resin compositions were obtained according to the same method as in Example 1, except that the materials and formulation amounts (mass %) were respectively changed to those shown in Table 2 and Table 3.

### Example 15

The thermoplastic resin (A2-4) 89 mass %, the carbon nanotube (B-1) 1 mass %, and the carbon black (C-1) 10 mass % were mixed and melt-kneaded, then extruded at 280° C. using a twin-screw extruder (manufactured by The Japan Steel Works. LTD.), and pelletized to obtain the thermoplastic resin composition.

### Example 16

The thermoplastic resin (A3-5) 89 mass %, the carbon nanotube (B-1) 1 mass %, and the carbon black (C-1) 10 mass % were mixed and melt-kneaded, then extruded at 260° C. using a twin-screw extruder (manufactured by The Japan Steel Works, LTD.), and pelletized to obtain the thermoplastic resin composition.

### Example 17

The thermoplastic resin (A4-6) 89 mass %, the carbon nanotube (B-1) 1 mass %, and the carbon black (C-1) 10 mass % were mixed and melt-kneaded, then extruded at 280° C. using a twin-screw extruder (manufactured by The Japan Steel Works, LTD.), and pelletized to obtain the thermoplastic resin composition.

### Comparative Example 1

The thermoplastic resin (A5-7) 89 mass %, the carbon nanotube (B-1) 1 mass %, and the carbon black (C-1) 10 mass % were mixed and melt-kneaded, then extruded at 230° C. using a single-screw extruder (manufactured by The Japan Steel Works, LTD.), and pelletized to obtain the thermoplastic resin composition.

### Comparative Example 2 and Comparative Example 4 to Comparative Example 10

Thermoplastic resin compositions were obtained according to the same method as in Comparative Example 1, except that the materials and formulation amounts (mass %) were respectively changed to those shown in Table 3 and Table 4.

### Comparative Example 3

The thermoplastic resin (A5-9) 89 mass %, the carbon nanotube (B-1) 1 mass %, and the carbon black (C-1) 10 mass % were mixed and melt-kneaded, then extruded at 280° C. using a single-screw extruder (manufactured by The Japan Steel Works, LTD.), and pelletized to obtain the thermoplastic resin composition.

### <<Physical Properties and Evaluation of Thermoplastic Resin Composition>>

The physical properties and evaluation results of the obtained thermoplastic resin compositions were determined according to the following methods. The results are shown in Table 2 to Table 4.

### <Measurement of Transmission Attenuation Amount and Reflection Attenuation Amount>

The thermoplastic resin compositions obtained according to Example 1 to Example 14 and Comparative Example 1 to Comparative Example 13 were injection molded using an injection molding machine (manufactured by Toshiba Machine Co., Ltd.) at a cylinder set temperature of 220° C. and a mold temperature of 40° C. to produce molded bodies of 90 mm in length (injection direction), 110 mm in width (direction perpendicular to the injection direction), and 3 mm in thickness.

The thermoplastic resin compositions obtained according to Example 15 and Example 17 were injection molded using an injection molding machine (manufactured by Toshiba Machine Co., Ltd.) at a cylinder set temperature of 280° C. and a mold temperature of 80° C. to produce molded bodies of 90 mm in length (injection direction), 110 mm in width (direction perpendicular to the injection direction), and 3 mm in thickness.

The thermoplastic resin composition obtained according to Example 16 was injection molded using an injection molding machine (manufactured by Toshiba Machine Co., Ltd.) at a cylinder set temperature of 260° C. and a mold temperature of 40° C. to produce a molded body of 90 mm in length (injection direction), 110 mm in width (direction perpendicular to the injection direction), and 3 mm in thickness.

Further, the length of the molded body is in the injection direction.

Using the obtained molded bodies, the reflection attenuation amount RL(TD) and the transmission attenuation amount TL(TD), of cases where the electric field direction of the electromagnetic waves is in a direction (MD direction) parallel to the injection direction of the molded body and in a direction (TD direction) perpendicular to the injection direction, were measured according to the following method.

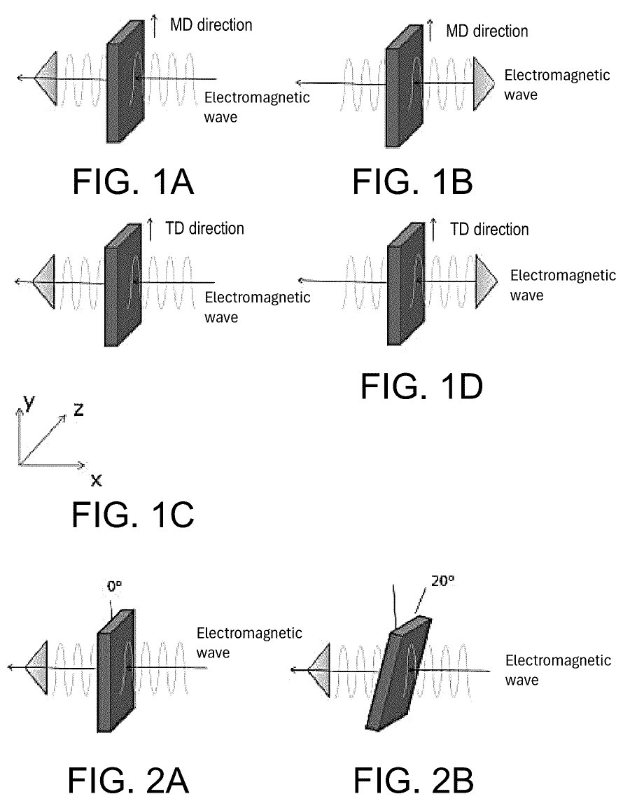

FIG. 1 is a conceptual view of measurements of 1. the transmission attenuation amount TL(MD), 2. the reflection attenuation amount RL(MD), 3. the transmission attenuation amount RL(TD), and 4. the reflection attenuation amount RL(TD), when electromagnetic waves are incident onto the thickness direction of the molded body, that is, when the plane of the molded body is left standing in the emission direction of the electromagnetic waves, with (x) representing the irradiation direction of the electromagnetic waves. (y) representing the electric field direction, and (z) representing the magnetic field direction.

As shown in 1, and 2. of FIG. 1, after the obtained molded body was left standing for one day, the reflection attenuation amount RL(MD) and the transmission attenuation amount TL(MD) were measured in a state in which the electric field direction (y direction in the figure) of the electromagnetic waves was in a direction (MD direction) parallel to the injection direction.

Further, as shown in 3, and 4. of FIG. 1, after the obtained molded body was left standing for one day, the reflection attenuation amount RL(TD) and the transmission attenuation amount TL(TD) were measured in a state in which the electric field direction (y direction in the figure) of the electromagnetic waves was in a direction (TD direction) perpendicular to the injection direction.

Using E8257D+E8257DS12 (output: 4 dBm) as a millimeter wave transmission device, N9030A+M1970V as a millimeter wave reception device, and AAHR015 (WR15, AET, INC) (all manufactured by Keysight Technologies) as a horn antenna, the reflection attenuation amount and the transmission attenuation amount of the obtained molded body at a measurement frequency of 76.5 GHz were measured under an environment of a temperature of 24.8° C. and a relative humidity of 48%.

Based on the obtained reflection attenuation amounts RL(MD) and RL(TD) and the obtained transmission attenuation amounts TL(MD) and TL(TD), an incident angle dependence ΔRL in the reflection attenuation amount and an incident angle dependence ΔTL in the transmission attenuation amount were calculated according to Equation (1) and Equation (2) below.

$$Δ RL = \vert RL ( MD ) - RL ( TD ) \vert \qquad Equation ( 1 )$$

$$Δ TL = \vert TL ( MD ) - TL ( TD ) \vert \qquad Equation ( 2 )$$

### <Dispersibility>

The obtained thermoplastic resin composition for an electromagnetic wave absorber was extruded using a T-die molding machine (manufactured by TOYO SEIKI co., LTD.) at a cylinder set temperature of 220° C. and a mold temperature of 40° C. to produce a T-die film of 10 cm in width×5 m in length×100 μm in thickness.

The obtained T-die film was observed under an optical microscope (manufactured by Keyence), and a quantity of lumps of 100 μm or more was counted to perform evaluation on dispersibility according to the following criteria.

### [Evaluation Criteria]

◯ (Good): Lump quantity is less than 30.

Δ (Acceptable for practical use): Lump quantity is 30 or more and less than 50.

x (Not acceptable for practical use): Lump quantity is 50 or more.

### <Electromagnetic Wave Absorption Performance>

### (Reflection Loss RL(MD))

As an indicator of electromagnetic wave absorption performance, a reflection loss (dB) in the millimeter wave frequency band was measured according to the following method.

Using E8257D+E8257DS12 (output: 4 dBm) as a millimeter wave transmission device, N9030A+M1970V as a millimeter wave reception device, and AAHR015 (WR15, AET, INC) (all manufactured by Keysight Technologies) as a horn antenna, the reflection loss at a measurement frequency of 76.5 GHz in a state in which the electric field direction (y direction in the figure) of the electromagnetic waves was in a direction parallel to the injection direction (MD direction) was measured for the molded bodies obtained in Examples and Comparative Examples, under an environment of a temperature of 24.8° C. and a relative humidity of 48%.

As electromagnetic wave absorption performance, an evaluation on the reflection loss RL(MD) was performed according to the following criteria.

### [Evaluation Criteria]

∘ (Good): Reflection loss is less than −6 dB.

Δ (Acceptable for practical use): Reflection loss is −6 dB or more and less than −5 dB.

x (Not acceptable for practical use): Reflection loss is −5 dB or more.

### (Transmission Loss TL(MD))

As an indicator of electromagnetic wave absorption performance, a transmission loss (dB) in the millimeter wave frequency band was measured according to the following method.

Using E8257D+E8257DS12 (output: 4 dBm) as a millimeter wave transmission device, N9030A+M1970V as a millimeter wave reception device, AAHR015 (WR15, AET, INC) (all manufactured by Keysight Technologies) as a horn antenna, the transmission loss at a measurement frequency of 76.5 GHz in a state in which the electric field direction (y direction in the figure) of the electromagnetic waves was in a direction parallel to the injection direction (MD direction) was measured for the molded bodies obtained in Examples and Comparative Examples, under an environment of a temperature of 24.8° C. and a relative humidity of 48%.

As electromagnetic wave absorption performance, an evaluation on the transmission loss TL(MD) was performed according to the following criteria.

### [Evaluation Criteria]

∘ (Good): Transmission loss is less than −15 dB.

Δ (Acceptable for practical use): Transmission loss is −15 dB or more and less than −10 dB.

x (Not acceptable for practical use): Transmission loss is −10 dB or more.

### <Incident Angle Dependence>

The angle dependence was evaluated based on the incident angle dependence according to the following method.

Using E8257D+E8257DS12 (output: 4 dBm) as a millimeter wave transmission device, N9030A+M1970V as a millimeter wave reception device, AAHR015 (WR15, AET, INC) (all manufactured by Keysight Technologies) as a horn antenna, the reflection loss and the transmission loss at a measurement frequency of 76.5 GHz in a state in which the electric field direction (y direction in the figure) of the electromagnetic waves was in a direction parallel to the injection direction (MD direction) were measured for the molded bodies obtained in Examples and Comparative Examples, under an environment of a temperature of 24.8° C. and a relative humidity of 48%.

Further, in this measurement, the molded body was positioned at an angle of 20° with respect to the irradiation direction of the electromagnetic waves, and the measurement was performed (FIG. 2 is a conceptual view illustrating the measurement of the transmission loss as an example).

As the incident angle dependence, an evaluation on the reflection loss RL(MD) was performed according to the following criteria.

### [Evaluation Criteria]

∘ (Good): Reflection loss is less than −5 dB.

Δ (Acceptable for practical use): Reflection loss is −5 dB or more and less than −3 dB.

x (Not acceptable for practical use): Reflection loss is −3 dB or more.

Further, as the incident angle dependence, an evaluation on the transmission loss TL(MD) was performed according to the following criteria.

### [Evaluation Criteria]

∘ (Good): Transmission loss is less than −15 dB.

Δ (Acceptable for practical use): Transmission loss is −15 dB or more and less than −10 dB.

x (Not acceptable for practical use): Transmission loss is −10 dB or more.

TABLE 2

| | | | Exam- | Exam- | Exam- | Exam- | Exam- | Exam- | Exam- | Exam- | Exam- | Exam- |
|---|---|---|---|---|---|---|---|---|---|---|---|---|
| | | | ple 1 | ple 2 | ple 3 | ple 4 | ple 5 | ple 6 | ple 7 | ple 8 | ple 9 | ple 10 |
| Thermo- | Thermo- | A1-1 | 89 | 89 | 89 | 89 | 89 | 89 | 89 | 91 | 87 | 89.5 |
| plastic | plastic | A1-2 | | | | | | | | | | |
| resin | resin (A) | A1-3 | | | | | | | | | | |
| composition | | A2-4 | | | | | | | | | | |
| | | A3-5 | | | | | | | | | | |
| | | A4-6 | | | | | | | | | | |
| | | A5-7 | | | | | | | | | | |
| | | A5-8 | | | | | | | | | | |
| | | A5-9 | | | | | | | | | | |
| | Carbon | B-1 | 1 | 1 | 1 | | | | | | 4 | 0.5 |
| | nanotube | B-2 | | | | 1 | 1 | 1 | | | | |
| | (B) and the | B-3 | | | | | | | 1 | 2 | | |
| | like | B′-1 | | | | | | | | | | |
| | Carbon | C-1 | 10 | | | 10 | | | 10 | 7 | 10 | 10 |
| | black (C) | C-2 | | 10 | | | 10 | | | | | |
| | and the like | C-3 | | | 10 | | | 10 | | | | |
| | | C′-1 | | | | | | | | | | |
| | | C′-2 | | | | | | | | | | |
| Equation (1) ΔRL | | | 0.4 | 0.5 | 1.1 | 0.6 | 0.8 | 1.6 | 1.6 | 0.8 | 0.7 | 0.1 |
| Equation (2) ΔTL | | | 1.3 | 2.9 | 3.8 | 1.9 | 3.2 | 4.6 | 4.1 | 2.8 | 2.2 | 0.9 |
| Evaluation | Dispersibility | Lump | 15 | 21 | 32 | 18 | 25 | 37 | 19 | 16 | 26 | 10 |
| on thermo- | | quantity | ∘ | ∘ | Δ | ∘ | ∘ | Δ | ∘ | ∘ | ∘ | ∘ |
| plastic | | | | | | | | | | | | |
| resin | | | | | | | | | | | | |
| composition | | | | | | | | | | | | |
| Evaluation | Electromagnetic | Reflection | −7.3 | −7.1 | −6.2 | −7.2 | −6.7 | −5.5 | −7.1 | −7.4 | −5.2 | −8.3 |
| on molded | wave | loss | ∘ | ∘ | ∘ | ∘ | ∘ | Δ | ∘ | ∘ | Δ | ∘ |
| body | absorption | RL(MD) | | | | | | | | | | |
| | performance | Transmission | −16 | −17 | −24 | −14 | −16 | −20 | −18 | −14 | −28 | −12 |
| | | loss | ∘ | ∘ | ∘ | Δ | ∘ | ∘ | ∘ | Δ | ∘ | Δ |
| | | TL(MD) | | | | | | | | | | |
| | Incident | Reflection | −6.6 | −6.2 | −4.5 | −6.3 | −4.8 | −3.8 | −4.2 | −6.5 | −4.6 | −7.7 |
| | angle | loss | ∘ | ∘ | Δ | ∘ | Δ | Δ | Δ | ∘ | Δ | ∘ |
| | dependence | RL(MD) | | | | | | | | | | |
| | (20°) | Transmission | −18 | −22 | −23 | −22 | −22 | −30 | −26 | −19 | −30 | −16 |
| | | loss | ∘ | ∘ | ∘ | ∘ | ∘ | ∘ | ∘ | ∘ | ∘ | ∘ |
| | | TL(MD) | | | | | | | | | | |

TABLE 3

| | | | | | | | | | | Compar- | Compar- | Compar- |
|---|---|---|---|---|---|---|---|---|---|---|---|---|
| | | | | | | | | | | ative | ative | ative |
| | | | Exam- | Exam- | Exam- | Exam- | Exam- | Exam- | Exam- | Exam- | Exam- | Exam- |
| | | | ple 11 | ple 12 | ple 13 | ple 14 | ple 15 | ple 16 | ple 17 | ple 1 | ple 2 | ple 3 |
| Thermo- | Thermo- | A1-1 | 84 | 94 | | | | | | | | |
| plastic | plastic | A1-2 | | | 89 | | | | | | | |
| resin | resin (A) | A1-3 | | | | 89 | | | | | | |
| composition | | A2-4 | | | | | 89 | | | | | |
| | | A3-5 | | | | | | 89 | | | | |
| | | A4-6 | | | | | | | 89 | | | |
| | | A5-7 | | | | | | | | 89 | | |
| | | A5-8 | | | | | | | | | 89 | |
| | | A5-9 | | | | | | | | | | 89 |
| | Carbon | B-1 | 1 | 1 | 1 | 1 | 1 | 1 | 1 | 1 | 1 | 1 |
| | nanotube | B-2 | | | | | | | | | | |
| | (B) and the | B-3 | | | | | | | | | | |
| | like | B′-1 | | | | | | | | | | |
| | Carbon | C-1 | 15 | 5 | 10 | 10 | 10 | 10 | 10 | 10 | 10 | 10 |
| | black (C) | C-2 | | | | | | | | | | |
| | and the like | C-3 | | | | | | | | | | |
| | | C′-1 | | | | | | | | | | |
| | | C′-2 | | | | | | | | | | |
| Equation (1) ΔRL | | | 2.7 | 0.9 | 2.2 | 1.8 | 0.6 | 0.5 | 0.7 | 3.7 | 5.3 | 8.0 |
| Equation (2) ΔTL | | | 4.0 | 1.2 | 4.3 | 3.1 | 1.5 | 1.3 | 1.8 | 5.5 | 8.9 | 11.2 |
| Evaluation | Dispersibility | Lump | 31 | 8 | 19 | 14 | 22 | 18 | 22 | 14 | 40 | 75 |
| on thermo- | | quantity | Δ | ∘ | ∘ | ∘ | ∘ | ∘ | ∘ | ∘ | Δ | x |
| plastic | | | | | | | | | | | | |
| resin | | | | | | | | | | | | |
| composition | | | | | | | | | | | | |
| Evaluation | Electromagnetic | Reflection | −5.2 | −7.7 | −6.4 | −6.5 | −6.9 | −7.0 | −6.8 | −6.9 | −6.5 | −6.0 |
| on molded | wave | loss | Δ | ∘ | ∘ | ∘ | ∘ | ∘ | ∘ | ∘ | ∘ | Δ |
| body | absorption | RL(MD) | | | | | | | | | | |
| | performance | Transmission | −26 | −15 | −17 | −16 | −16 | −17 | −16 | −16 | −17 | −19 |
| | | loss | ∘ | Δ | ∘ | ∘ | ∘ | ∘ | ∘ | ∘ | ∘ | ∘ |
| | | TL(MD) | | | | | | | | | | |
| | Incident | Reflection | −3.5 | −6.4 | −3.8 | −4.2 | −6.3 | −6.5 | −6.0 | −2.5 | −2.1 | −1.5 |
| | angle | loss | Δ | ∘ | Δ | Δ | ∘ | ∘ | ∘ | x | x | x |
| | dependence | RL(MD) | | | | | | | | | | |
| | (20°) | Transmission | −32 | −19 | −26 | −24 | −18 | −17 | −18 | −24 | −27 | −32 |
| | | loss | ∘ | ∘ | ∘ | ∘ | ∘ | ∘ | ∘ | ∘ | ∘ | ∘ |
| | | TL(MD) | | | | | | | | | | |

TABLE 4

| | | | Comparative | Comparative | Comparative | Comparative | Comparative |
|---|---|---|---|---|---|---|---|
| | | | Example 4 | Example 5 | Example 6 | Example 7 | Example 8 |
| Thermo- | Thermo- | A1-1 | 89 | 94 | 89 | 94 | 89 |
| plastic | plastic | A1-2 | | | | | |
| resin | resin (A) | A1-3 | | | | | |
| composition | | A2-4 | | | | | |
| | | A3-5 | | | | | |
| | | A4-6 | | | | | |
| | | A5-7 | | | | | |
| | | A5-8 | | | | | |
| | | A5-9 | | | | | |
| | Carbon | B-1 | | | 1 | 1 | 1 |
| | nanotube | B-2 | | | | | |
| | (B) and the | B-3 | | | | | |
| | like | B′-1 | 1 | 1 | | | |
| | Carbon | C-1 | 10 | 5 | | | |
| | black (C) | C-2 | | | | | |
| | and the like | C-3 | | | | | |
| | | C′-1 | | | 10 | 5 | |
| | | C′-2 | | | | | 10 |
| Equation (1) ΔRL | | | 3.8 | 0.9 | 5.6 | 2.5 | 3.5 |
| Equation (2) ΔTL | | | 6.9 | 2.0 | 7.5 | 3.9 | 5.0 |
| Evaluation | Dispersibility | Lump | 34 | 26 | 55 | 40 | 83 |
| on thermo- | | quantity | Δ | ∘ | x | Δ | x |
| plastic | | | | | | | |
| resin | | | | | | | |
| composition | | | | | | | |
| Evaluation | Electromagnetic | Reflection | −6.5 | −8.0 | −6.1 | −6.5 | −6.8 |
| on molded | wave | loss | ∘ | ∘ | ∘ | ∘ | ∘ |
| body | absorption | RL(MD) | | | | | |
| | performance | Transmission | −20 | −9.5 | −13 | −7.3 | −6.9 |
| | | loss | ∘ | x | Δ | x | x |
| | | TL(MD) | | | | | |
| | Incident | Reflection | −2.8 | −6.8 | −2.0 | −4.6 | −2.7 |
| | angle | loss | x | ∘ | x | Δ | x |
| | dependence | RL(MD) | | | | | |
| | (20°) | Transmission | −23 | −12 | −35 | −9.1 | −9.4 |
| | | loss | ∘ | Δ | ∘ | x | x |
| | | TL(MD) | | | | | |
| | | | Comparative | Comparative | Comparative | Comparative | Comparative |
| | | | Example 9 | Example 10 | Example 11 | Example 12 | Example 13 |
| Thermo- | Thermo- | A1-1 | 94 | 99 | 90 | 80 | 74 |
| plastic | plastic | A1-2 | | | | | |
| resin | resin (A) | A1-3 | | | | | |
| composition | | A2-4 | | | | | |
| | | A3-5 | | | | | |
| | | A4-6 | | | | | |
| | | A5-7 | | | | | |
| | | A5-8 | | | | | |
| | | A5-9 | | | | | |
| | Carbon | B-1 | 1 | 1 | | 10 | 1 |
| | nanotube | B-2 | | | | | |
| | (B) and the | B-3 | | | | | |
| | like | B′-1 | | | | | |
| | Carbon | C-1 | | | 10 | 10 | 25 |
| | black (C) | C-2 | | | | | |
| | and the like | C-3 | | | | | |
| | | C′-1 | | | | | |
| | | C′-2 | 5 | | | | |
| Equation (1) ΔRL | | | 4.5 | 0.3 | 0.3 | 6.2 | 7.8 |
| Equation (2) ΔTL | | | 7.1 | 0.8 | 1.0 | 10.2 | 11.8 |
| Evaluation | Dispersibility | Lump | 69 | 10 | 23 | 112 | 46 |
| on thermo- | | quantity | x | ∘ | ∘ | x | Δ |
| plastic | | | | | | | |
| resin | | | | | | | |
| composition | | | | | | | |
| Evaluation | Electromagnetic | Reflection | −7.4 | −7.6 | −7.0 | −1.8 | −0.9 |
| on molded | wave | loss | ∘ | ∘ | ∘ | x | x |
| body | absorption | RL(MD) | | | | | |
| | performance | Transmission | −6.5 | −4.9 | −7.9 | −31 | −36 |
| | | loss | x | x | x | ∘ | ∘ |
| | | TL(MD) | | | | | |
| | Incident | Reflection | −2.4 | −6.5 | −5.8 | −1.4 | −0.9 |
| | angle | loss | x | ∘ | ∘ | x | x |
| | dependence | RL(MD) | | | | | |
| | (20°) | Transmission | −8.0 | −6.5 | −11.2 | −33 | −37 |
| | | loss | x | x | Δ | ∘ | ∘ |
| | | TL(MD) | | | | | |

Regarding the thermoplastic resins of Example 2 to Example 12, the thermoplastic resin compositions formed by replacing the thermoplastic resin (A1-1) respectively with the thermoplastic resin (A2-4), the thermoplastic resin (A3-5), and the thermoplastic resin (A4-6) had evaluation results similar to the case using the thermoplastic resin (A1-1).

In other words, effects in forms of all of (i) to (iv) were confirmed.

According to the above evaluation results, the thermoplastic resin composition according to the embodiment of the present invention and the molded body using the same are excellent in dispersibility as a resin composition, the molded body exhibits excellent electromagnetic wave absorption performance with both a low reflection loss and a low transmission loss, and even in the case of electromagnetic waves incident at a changed incident angle, it is possible to stably exhibit electromagnetic wave absorption performance, thus confirming excellent results in suppression of angle dependence.

Specifically, since the embodiment is excellent in terms of the reflection loss and the transmission loss in the specific frequency band of 60 to 90 GHz, which is called millimeter waves, it can be said that it may also be suitably used as a molded body for a millimeter wave absorber.

1. A thermoplastic resin composition for an electromagnetic wave absorber comprising:
a thermoplastic resin (A), a carbon nanotube (B) with an average diameter of 1 to 15 nm, and a carbon black (C) with an average primary particle size of 20 to 50 nm,
the thermoplastic resin composition for an electromagnetic wave absorber satisfying any of (i) to (iv) below, wherein
ΔRL expressed by Equation (1) below is 3 dB or less, and ΔTL expressed by Equation (2) below is 5 dB or less,
(i): the thermoplastic resin (A) comprises a polyolefin resin (A1) with an MFR of 5.0 to 50 g/10 min at a temperature of 230° C. and a load of 2.16 kgf;
(ii): the thermoplastic resin (A) comprises a polyamide resin (A2) with an MFR of 5.0 to 50 g/10 min at a temperature of 240° C. and a load of 2.16 kgf;
(iii): the thermoplastic resin (A) comprises a polyester resin (A3) with an MFR of 5.0 to 50 g/10 min at a temperature of 280° C. and a load of 1.2 kgf;
(iv): the thermoplastic resin (A) comprises a polycarbonate resin (A4) with an MFR of 5.0 to 50 g/10 min at a temperature of 280° C. and a load of 1.2 kgf;
$$Δ RL = \vert RL ( MD ) - RL ( TD ) \vert \qquad Equation ( 1 )$$
$$Δ TL = \vert TL ( MD ) - TL ( TD ) \vert \qquad Equation ( 2 )$$
where RL(MD) and RL(TD) are respectively reflection attenuation amounts when electromagnetic waves with a frequency of 76.5 GHz are incident onto a thickness direction of a molded body, with an electric field direction of the electromagnetic waves being in a direction, which is an MD direction, parallel to an injection direction or in a direction, which is a TD direction, perpendicular to the injection direction, after leaving the molded body standing for one day, the molded body being 90 mm in length, 110 mm in width, and 3 mm in thickness and is molded from the thermoplastic resin composition for an electromagnetic wave absorber using an injection molding machine,
further, TL(MD) and TL(TD) are respectively transmission attenuation amounts when electromagnetic waves with a frequency of 76.5 GHz are incident onto a thickness direction of a molded body, with an electric field direction of the electromagnetic waves being in a direction, which is an MD direction, parallel to an injection direction or in a direction, which is a TD direction, perpendicular to the injection direction, after leaving the molded body standing for one day, the molded body being 90 mm in length, 110 mm in width, and 3 mm in thickness and is molded from the thermoplastic resin composition for an electromagnetic wave absorber using an injection molding machine, and
further, the length of the molded body is in the injection direction.

2. The thermoplastic resin composition for an electromagnetic wave absorber according to claim 1, wherein based on the thermoplastic resin composition for an electromagnetic wave absorber, a total content ratio of the carbon nanotube (B) and the carbon black (C) is 6 to 18 mass %.

3. The thermoplastic resin composition for an electromagnetic wave absorber according to claim 1, wherein based on the thermoplastic resin composition for an electromagnetic wave absorber, a content ratio of the thermoplastic resin (A) is 82 to 94 mass %, a content ratio of the carbon nanotube (B) is 1 to 3 mass %, and a content ratio of the carbon black (C) is 5 to 15 mass %.

4. A molded body formed from the thermoplastic resin composition for an electromagnetic wave absorber according to claim 1.
